(19) United States
(12) Patent Application Publication
(10) Pub. No.: US 2010/0199801 A1
(43) Pub. Date: Aug. 12, 2010

(54) AERODYNAMICALLY CONFIGURED HANDLEBAR ASSEMBLY FOR A BICYCLE

(75) Inventor: Hua-Chun Huang, Jhonghe (TW)

Correspondence Address: FOX ROTHSCHILD LLP;PRINCETON PIKE CORPORATE CENTER, 997 LENOX DRIVE, BLDG. #3, LAWRENCEVILLE, NJ, 08648, US

(73) Assignee: GIANT MANUFACTURING CO., LTD., Taichung Hsien (TW)

(21) Appl. No.: 12/370,349

(22) Filed: Feb. 12, 2009

(51) Int. Cl. B62K 21/12

(52) U.S. Cl. 74/551.3

(57) ABSTRACT

An aerodynamically configured handlebar assembly for use in a bicycle includes a mounting head which has a rear clamping body for clamping an upper end of a steering stem of a bicycle front fork so as to cantilever a front aerodynamic body of the mounting head, a handlebar body which extends laterally from opposite sides of the front aerodynamic body and which has handgrips at leftmost and rightmost ends thereof, and an aerodynamic bracket member which is disposed beneath the front aerodynamic body and which has a rear crosspiece. The crosspiece is secured to a crotch segment of the bicycle front fork by a fastening unit so as to enable the bracket member to better support weight of the cantilevered front aerodynamic body.

### CROSS-REFERENCE TO RELATED APPLICATION

This application claims the benefit of the Taiwan Patent Application No. 097142389, filed Nov. 3, 2008.

### BACKGROUND OF THE INVENTION

1. Field of the Invention

This invention relates to a handlebar assembly for a bicycle, more particularly to an aerodynamically configured handlebar assembly which is provided with armrests.

2. Description of the Related Art

Referring to FIGS. 1 and 2, an aerodynamic fork mast structure for use in a bicycle 1 disclosed in U.S. Publication No. 20080036170A1 is shown to include a frame 11, a front fork 12 pivotally connected to a head tube of the frame 11, and a handlebar 13. The front fork 12 includes an upwardly extending mast 121 and a pair of fork arms 122 opposite to the mast 121. The handlebar 13 includes a bracket 131 which has a clamp 133 for clamping the mast 121, and two extensions 132 which extend forwardly from the bracket 131 and which serve as handgrips for supporting a rider's arms. Since the clamp 133 is provided at a rear side of the handlebar 13, the extensions 132 are cantilevered forwardly of the front fork 12. When the rider's arms rest on the extensions 132, the extensions 132 are subjected to the weight and pressing force of the rider so that the attachment of the handlebar 13 to the mast 121 may not be sufficiently strong, and the steering operation of the handlebar 13 is adversely affected, which may cause danger to the rider, particularly during racing at a high speed.

### SUMMARY OF THE INVENTION

An object of the present invention is to provide an aerodynamically configured handlebar assembly for use in a bicycle, which can be firmly secured to a front fork of the bicycle, which can minimize headwind resistance, which has a robust structure for supporting a rider's arms, and which permits smooth steering of the bicycle.

According to this invention, the aerodynamically configured handlebar assembly includes a mounting head which includes a front aerodynamic body that extends forwardly to terminate at a nose end, and a rear clamping body that is adapted to clamp a steering stem of a bicycle front fork so as to cantilever the front aerodynamic body. Left and right mounting bars respectively extend from opposite sides of the front aerodynamic body to terminate at leftmost and rightmost ends. Left and right handgrips are respectively disposed on the leftmost and rightmost ends. An aerodynamic bracket member is disposed beneath the nose end, is shaped to minimize headwind resistance, and has a crosspiece which is disposed to be secured to a crotch segment of the bicycle front fork by a fastening unit such that the aerodynamic bracket member helps support weight of the cantilevered front aerodynamic body.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is a schematic side view of a fork mast structure for a bicycle disclosed in U.S. Publication No. 20080036170A1 including a front fork and a handlebar;

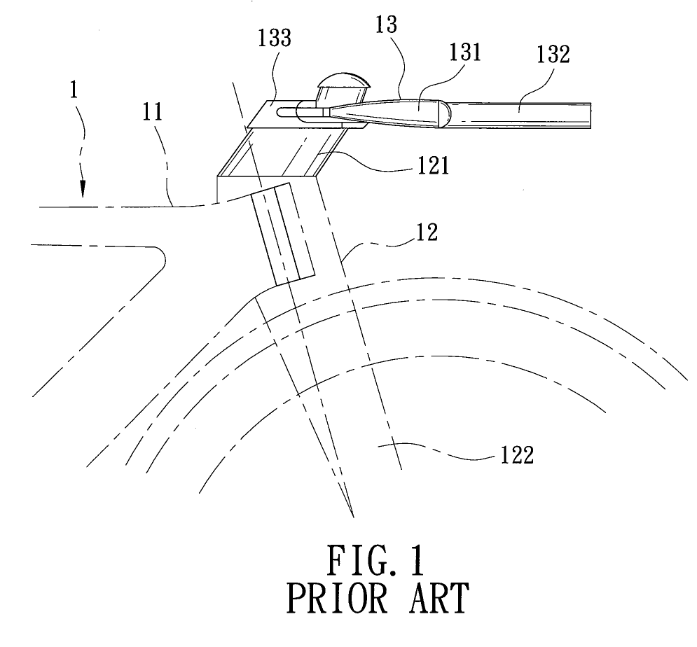

FIG. 2 is a perspective view of the fork mast structure of FIG. 1, illustrating a mounting bracket with a clamp;

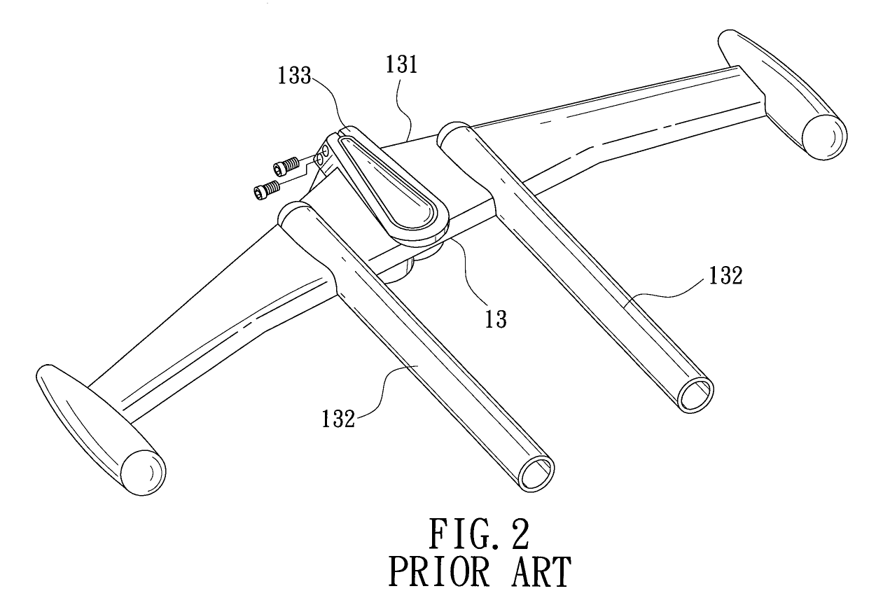

FIG. 3 is a sectional view of the preferred embodiment of an aerodynamically configured handlebar assembly according to this invention when attached to a bicycle frame;

FIG. 4 is an exploded perspective view of the preferred embodiment; and

FIG. 5 is a perspective view of the preferred embodiment.

### DETAILED DESCRIPTION OF THE PREFERRED EMBODIMENT

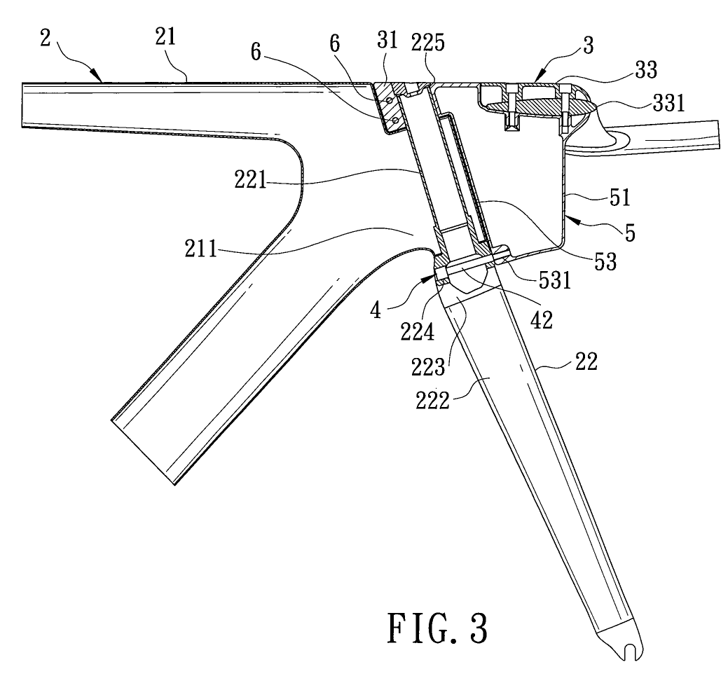

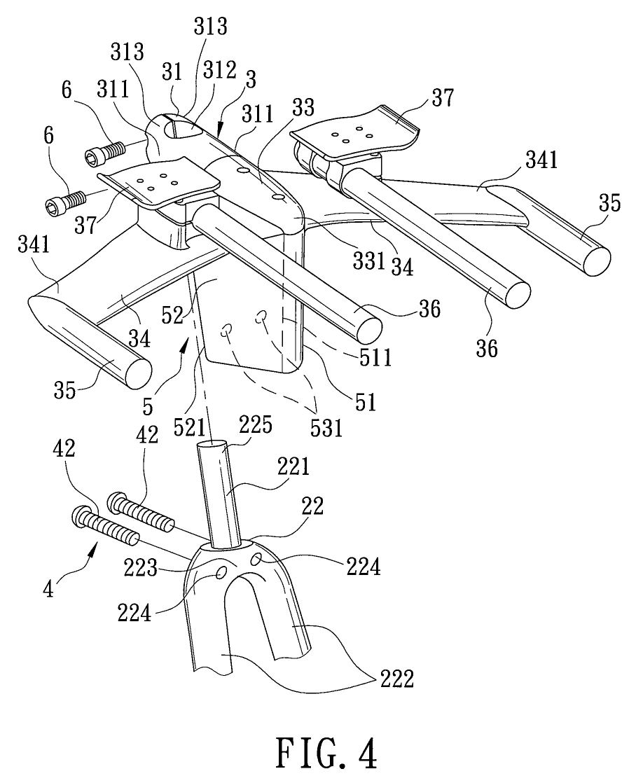

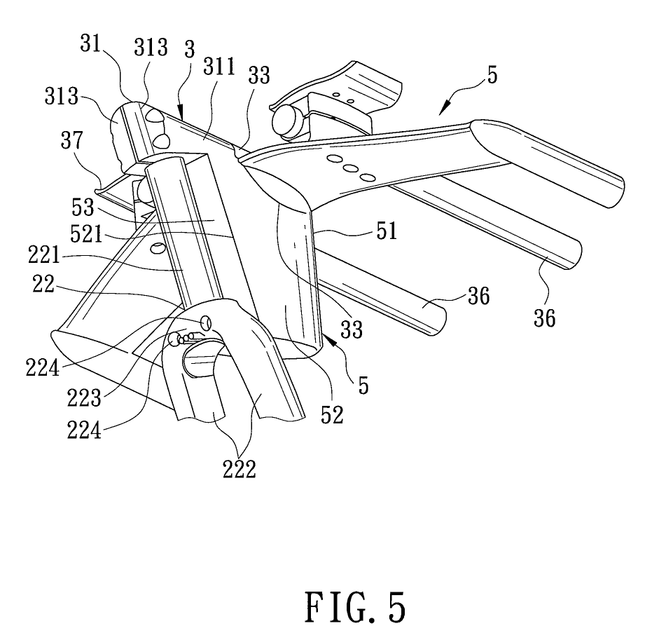

Referring to FIGS. 3 to 5, the preferred embodiment of an aerodynamically configured handlebar assembly according to the present invention is attached to a bicycle 2. The bicycle 2 includes a frame 21 which has a head tube 211 that extends along a swiveling axis in an upright direction, and a front fork 22 that includes a pair of fork arms 222, a crotch segment 223 interconnecting the fork arms 222, and a steering stem 221 that extends upwardly from the crotch segment 223 to terminate at an upper end 225 and that is coupled with the head tube 211 in a known manner so as to be swivelable about the swiveling axis.

The aerodynamically configured handlebar assembly according to this embodiment is shown to comprise amounting head 3, a handlebar body, an aerodynamic bracket member 5, and a fastening unit 4.

The mounting head 3 includes a front aerodynamic body 33 that extends forwardly to terminate at a nose end 331, and a rear clamping body 31 that is opposite to the front aerodynamic body 33 in a longitudinal direction. The rear clamping body 31 is in the form of a split clamp, and has left and right jaws 311 which extend rearwardly from the front aerodynamic body 33 and toward each other, which cooperatively define a bore 312 shaped and sized to permit insertion of the upper end 225 of the steering stem 221, and which respectively terminate at left and right tightening ends 313 that confront each other in a direction transverse to both the longitudinal direction and the upright direction. A plurality of tightening bolts 6 are disposed to tighten the left and right tightening ends 313 to each other to thereby secure the rear clamping body 31 to the upper end 225 and to thereby cantilever the front aerodynamic body 33.

The handlebar body includes left and right mounting bars 34, left and right mounting handgrips 35, left and right extensions 36, and left and right armrests 37. The left and right mounting bars 34 respectively extend from opposite sides of the front aerodynamic body 33 to terminate at leftmost and rightmost ends 341, respectively. The left and right handgrips 35 are respectively disposed on the leftmost and rightmost ends 341 and extend forwardly in the longitudinal direction. The left and right extensions 36 extend respectively and forwardly from the left and right mounting bars 34. The left and right armrests 37 are respectively disposed on the left and right extensions 36 proximate to the left and right mounting bars 34, respectively.

The aerodynamic bracket member 5 includes a front ridge portion 51, left and right lateral wall segments 52, and a crosspiece 53. The front ridge portion 51 is rounded, and has left and right junctures 511 that are opposite to each other in the transverse direction, that are disposed beneath the nose end 331, and that are spaced apart from the crotch segment 223 in the longitudinal direction. The left and right lateral wall segments 52 extend respectively and rearwardly from the left and right junctures 511, are disposed to diverge from each other so as to minimize headwind resistance, and terminate at left and right rear edges 521, respectively. The crosspiece 53 spans between the left and right rear edges 521, and is disposed to confront the crotch segment 223 in the longitudinal direction.

The fastening unit 4 includes a plurality of screw bolts 42 which extend in the longitudinal direction through holes 224 in the crotch segment 223 and which are threadedly engaged with a plurality of screw holes 531 in the crosspiece 53 so as to secure the crosspiece 53 to the crotch segment 223.

In this embodiment, the aerodynamic bracket member 5 is made from aluminum alloy, is integrally formed with the rear clamping body 31 of the mounting head 3, and is threadedly secured to the front aerodynamic body 33 of the mounting head 3. Alternatively, the mounting head 3 may be integrally formed with the aerodynamic bracket member 5 to cooperatively form a mount unit.

As illustrated, by means of the secure engagement between the rear clamping body 31 and the upper end 225 of the steering stem 221, and by means of the secure engagement between the crosspiece 53 and the crotch segment 223, the aerodynamic bracket member 5 can better support the weight of the handlebar body so as to effectively withstand the pressing forces applied to the extensions 36 when the rider's arms are rested on the armrests 37. Thus, the steering operation of the handlebar body can be smooth and safe. Furthermore, by virtue of the configuration of the aerodynamic bracket member 5, the handlebar assembly according to this invention, which is adapted to be secured to the front fork 22 of the bicycle 2, has a robust structure, and headwind resistance is minimized so that the bicycle 2 equipped with the handlebar assembly according to this invention is suitable for racing at a high speed.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

1. An aerodynamically configured handlebar assembly for use in a bicycle including a frame which has a head tube that extends along a swiveling axis in an upright direction, a pair of fork arms, a crotch segment that interconnects the fork arms, and a steering stem that extends upwardly from the crotch segment to terminate at an upper end and that is coupled with the head tube to be swivelable about the swiveling axis, said aerodynamically configured handlebar assembly comprising:
a mounting head which includes a front aerodynamic body that extends forwardly to terminate at a nose end, and a rear clamping body that is opposite to said front aerodynamic body in a longitudinal direction, said rear clamping body being adapted to clamp the upper end of the steering stem by virtue of tightening action in a direction transverse to both the longitudinal direction and the upright direction so as to cantilever said front aerodynamic body;
left and right mounting bars which extend respectively from opposite sides of said front aerodynamic body to terminate at leftmost and rightmost ends, respectively;
left and right handgrips which are respectively disposed on said leftmost and rightmost ends;
an aerodynamic bracket member including
a front ridge portion which has left and right junctures that are opposite to each other in the transverse direction, that are disposed beneath said nose end, and that are spaced apart from the crotch segment in the longitudinal direction,
left and right lateral wall segments which extend respectively and rearwardly from said left and right junctures, which diverge from each other so as to minimize headwind resistance, and which respectively terminate at left and right rear edges, and
a crosspiece which interconnects said left and right rear edges, and which is disposed to confront the crotch segment in the longitudinal direction; and
a fastening unit disposed to secure said crosspiece to the crotch segment such that said aerodynamic bracket member helps support weight of said front aerodynamic body.

2. The aerodynamically configured handlebar assembly according to claim 1, wherein said rear clamp body has left and right jaws which extend rearwardly from said front aerodynamic body and toward each other, which cooperatively define a bore shaped and sized to permit insertion of the upper end of the steering stem, and which respectively terminate at left and right tightening ends that confront each other in the transverse direction, and a tightening bolt disposed to tighten said left and right tightening ends to each other to thereby secure said rear clamping body to the upper end.

3. The aerodynamically configured handlebar assembly according to claim 1, wherein said fastening unit includes a screw bolt which extends in the longitudinal direction through the crotch segment and which is threadedly engaged with said crosspiece.

4. The aerodynamically configured handlebar assembly according to claim 1, wherein said front ridge portion is rounded.

5. The aerodynamically configured handlebar assembly according to claim 1, wherein said mounting head is integrally formed with said aerodynamic bracket member.

6. The aerodynamically configured handlebar assembly according to claim 1, wherein said aerodynamic bracket member is threadedly secured to said front aerodynamic body of said mounting head.

7. The aerodynamically configured handlebar assembly according to claim 1, further comprising left and right extensions which extend respectively and forwardly from said left and right mounting bars, and left and right armrests which are respectively disposed on said left and right extensions proximate to said left and right mounting bars, respectively.

8. An aerodynamically configured handlebar assembly for use in a bicycle including a frame and a front fork pivotally mounted on a front end portion of the frame, the front fork having a steering stem and a pair of fork arms disposed opposite to each other, said aerodynamically configured handlebar assembly comprising:
a mount unit including a mounting head and an aerodynamic bracket member which are opposite to each other in an upright direction and which are adapted to be secured to the front fork; and
a handlebar body mounted on said mount unit.

9. The aerodynamically configured handlebar assembly according to claim 8, wherein said mounting head is disposed to be secured to the steering stem.

10. The aerodynamically configured handlebar assembly according to claim 9, further comprising a tightening bolt, said mounting head including a rear clamping body which is configured to surround the steering stem, said tightening bolt being disposed to tighten said rear clamping body to the steering stem.

11. The aerodynamically configured handlebar assembly according to claim 10, wherein said rear clamping body has two tightening ends confronting each other, said tightening bolt being disposed to threadedly tighten said jaws to each other.

12. The aerodynamically configured handlebar assembly according to claim 8, wherein said aerodynamic bracket member is disposed to be secured to the fork arms.

13. The aerodynamically configured handlebar assembly according to claim 8, wherein the front fork further has a crotch segment that is interposed between the steering stem and the fork arms, said aerodynamic bracket member being disposed to be secured to the crotch segment.

14. The aerodynamically configured handlebar assembly according to claim 13, further comprising a fastening unit, said aerodynamic bracket member having a screw hole, said fastening unit including a screw bolt which extends through the crotch segment and which is threadedly engaged with said screw hole so as to secure said aerodynamic bracket member to the crotch segment.

15. An aerodynamically configured handlebar assembly for use in a bicycle including a frame which has a head tube, a pair of fork arms, a crotch segment that interconnects the fork arms, and a steering stem, said aerodynamically configured handlebar assembly comprising:
a mounting head which includes a front aerodynamic body that extends forwardly to terminate at a nose end;
an aerodynamic bracket member including
a front ridge portion, and
left and right lateral wall segments which diverge from each other so as to minimize headwind resistance;
a fastening unit disposed to secure said aerodynamic bracket member to one of the crotch segment and the fork arms such that said aerodynamic bracket member helps support weight of said front aerodynamic body; and
a handlebar body mounted between said mounting head and said aerodynamic bracket member.

16. The aerodynamically configured handlebar assembly according to claim 15, wherein said mounting head has a rear clamping body that is opposite to said front aerodynamic body in the longitudinal direction, and said rear clamping body is adapted to clamp the upper end of the steering stem by virtue of tightening action in a direction transverse to both the longitudinal direction and the upright direction so as to cantilever said front aerodynamic body.

17. The aerodynamically configured handlebar assembly according to claim 16, wherein said front ridge portion includes left and right junctures that are opposite to each other in the transverse direction, and that are disposed beneath said nose end, said left and right lateral wall segments extending respectively and rearwardly from said left and right junctures, and respectively terminating at left and right rear edges.

18. The aerodynamically configured handlebar assembly according to claim 17, wherein said aerodynamic bracket member further includes a crosspiece which interconnects said left and right rear edges, and which is disposed to confront the crotch segment in the longitudinal direction.
